(19) United States
(12) Patent Application Publication
(10) Pub. No.: US 2019/0133365 A1
(43) Pub. Date: May 9, 2019

(54) FILTERING AND STEEPING CONTAINER

(71) Applicant: LAU YAU MING, Kwai Chung (HK)

(72) Inventor: LAU YAU MING, Kwai Chung (HK)

(21) Appl. No.: 15/805,621

(22) Filed: Nov. 7, 2017

(51) Int. Cl. A47J 31/06; B65D 25/02; B65D 25/40; B65D 1/42; B65D 1/16

(52) U.S. Cl. CPC A47J 31/06; B65D 25/02; B65D 1/165; B65D 1/42; B65D 25/40

(57) ABSTRACT

A filtering and steeping container is revealed. The filtering and steeping container includes a container body and at least one soft and elastic netlike piece. At least two vertical ribs are integrally formed and projected from an inner wall of the container body. The netlike piece has a plurality of meshes. Two lateral sides of the netlike piece are slid along the two ribs respectively until a lower side of the netlike piece is close to an inner bottom surface of the container body while the netlike piece is inserted into the container body through an opening of the container body. A cavity of the container body is divided by the netlike piece to form a steeping chamber that is used for mounting at least one soaked object.

### BACKGROUND OF THE INVENTION

The present invention relates to a container, especially to a filtering and steeping container in which at least one soft and elastic netlike piece is inserted into a cavity of a container body so that the cavity of the container body is divided by the netlike piece to form a steeping chamber for mounting at least one soaked object. Thereby not only the container is convenient to use and easy to clean, the production cost of the container is also reduced.

There are various kinds of containers with filtering and steeping effects available on the market now. Most of them allow users/consumers to put at least one soaked object such as tea leaves, fruits, ice, etc. into a filter therein. Thus users can filter, steep or keep cool of the soaked object more easily and conveniently.

However, these prior arts have the following shortcomings:
(1). Although the container with the filter can provide at least one soaking space for immersing at least one soaked object in beverage, the container with the filter is difficult to clean and wash. For example, a vacuum flask is composed of a container body, a filter and a cover. For cleaning, firstly an assembly of the filter with the cover is removed from the container body and then the filter and the cover are separated from each other. Or remove the cover first and then disassemble the filter with the container body. Then each component is washed and cleaned in turn. Next the components are assembled again so that users can use the vacuum flask as usual. The disassembly process is complicated and tedious. The design is not convenient for users to clean the vacuum flask. (2). In order to mount the soaked object, the filter is usually produced with a cavity therein. The soaked object is placed into the cavity of the filter and then the filter is disposed on the container body. The production is difficult to be reduced owing to the complicated structure. Thus there is room for improvement and there is a need to provide a novel container that solves the problems mentioned above.

### SUMMARY OF THE INVENTION

Therefore it is a primary object of the present invention to provide a filtering and steeping container that includes a container body and at least one soft and elastic netlike piece. The container body consists of a cavity therein, an opening facing upward, an opening edge, an inner wall, an inner bottom surface and an inner bottom rim. The inner wall of the container body is integrated with at least two vertical ribs each of which is projecting from the inner wall of the container body toward the cavity and having a certain length and thickness. The rib is extended from an area close to the opening edge to the inner bottom surface of the container body. The netlike piece is composed of an upper side, a lower side, two lateral sides and a plurality of meshes. The netlike piece is inserted into the cavity through the opening of the container body. Thus the two lateral sides of the netlike piece are slid along the two ribs respectively and the lower side of the netlike piece is also moved downward to be close to the inner bottom surface of the container body. Then the two lateral sides are stopped and locked by the two ribs respectively owing to softness and elasticity of the netlike piece. The cavity of the container body is divided by the netlike piece to form a steeping chamber used for mounting at least one soaked object. By the meshes of the netlike piece, the steeping chamber is communicated with the cavity of the container body. Thereby not only the container is convenient to use and easy to clean, the production cost of the container is also lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a schematic drawing showing a partial sectional view of the embodiment in FIG. 1 according to the present invention;

FIG. 3 is a top view of the embodiment in FIG. 1 being assembled according to the present invention;

FIG. 4 is a sectional view of the embodiment in FIG. 1 being assembled according to the present invention;

FIG. 5 is an explosive view of another embodiment according to the present invention;

FIG. 6 is a top view of the embodiment in FIG. 5 being assembled according to the present invention;

FIG. 7 is a sectional view of the embodiment in FIG. 5 being assembled according to the present invention;

FIG. 8 is an explosive view of a further embodiment according to the present invention;

FIG. 9 is a top view of the embodiment in FIG. 8 being assembled according to the present invention;

FIG. 10 is a sectional view of the embodiment in FIG. 8 being assembled according to the present invention;

FIG. 11 is an explosive view of a further embodiment according to the present invention;

FIG. 12 is a sectional view of the embodiment in FIG. 11 being assembled according to the present invention;

FIG. 13 is an explosive view of a further embodiment according to the present invention;

FIG. 14 is a top view of the embodiment in FIG. 13 being assembled according to the present invention;

FIG. 15 is a sectional view of the embodiment in FIG. 13 being assembled according to the present invention;

FIG. 16 is a schematic drawing showing a top view of a further embodiment according to the present invention;

FIG. 17 is a schematic drawing showing a top view of a further embodiment according to the present invention;

FIG. 18 is a schematic drawing showing a top view of a further embodiment according to the present invention.

### DETAILED DESCRIPTION OF THE PROFFERED EMBODIMENTS

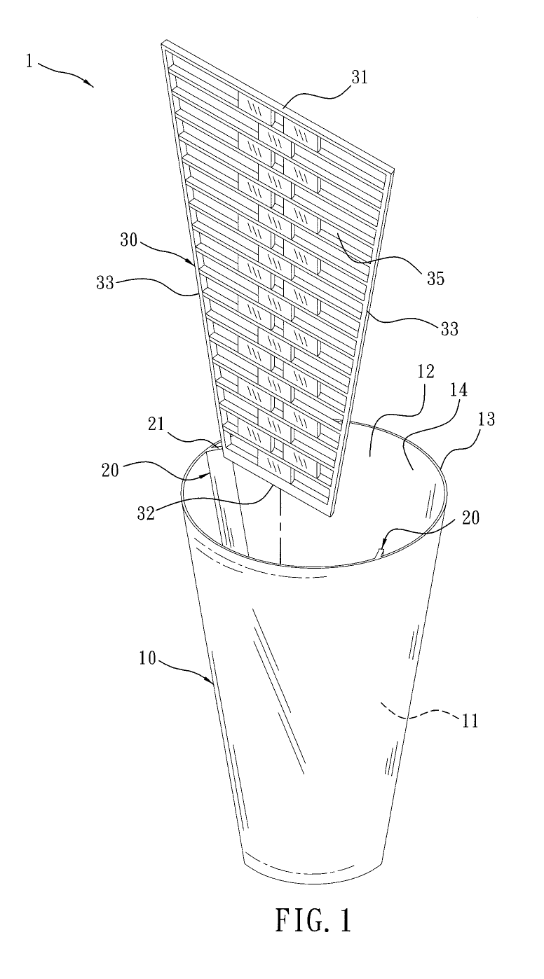

Refer to FIG. 1, a filtering and steeping container 1 includes a container body 10 and at least one netlike piece 30 that is soft and elastic.

10

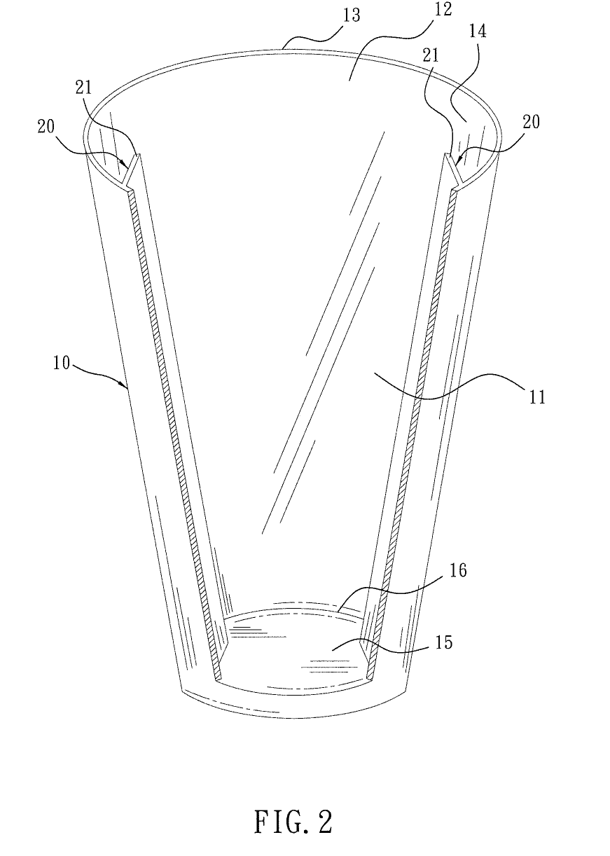

Refer to FIG. 2, the container body 10 is an integrally formed and including an inner cavity/chamber 11, an opening 12 facing upward, an opening edge 13, an inner wall 14, an inner bottom surface 15 and an inner bottom rim 16. At least two vertical ribs 20 are integrally formed on and projecting from the inner wall 14 of the container body 10. Each rib 20 having a certain length and thickness is projecting from the inner wall of the container body 10 toward the cavity 11. The rib 20 is also extended from an area close to the opening edge 13 of the container body 10 to the inner bottom surface 15. The shape of the cross section of the rib 20 is not limited, as long as it's simple and convenient to manufacture. For example, the container body 10 and the two ribs 20 are an integrated part produced by plastic injection molding in this embodiment.

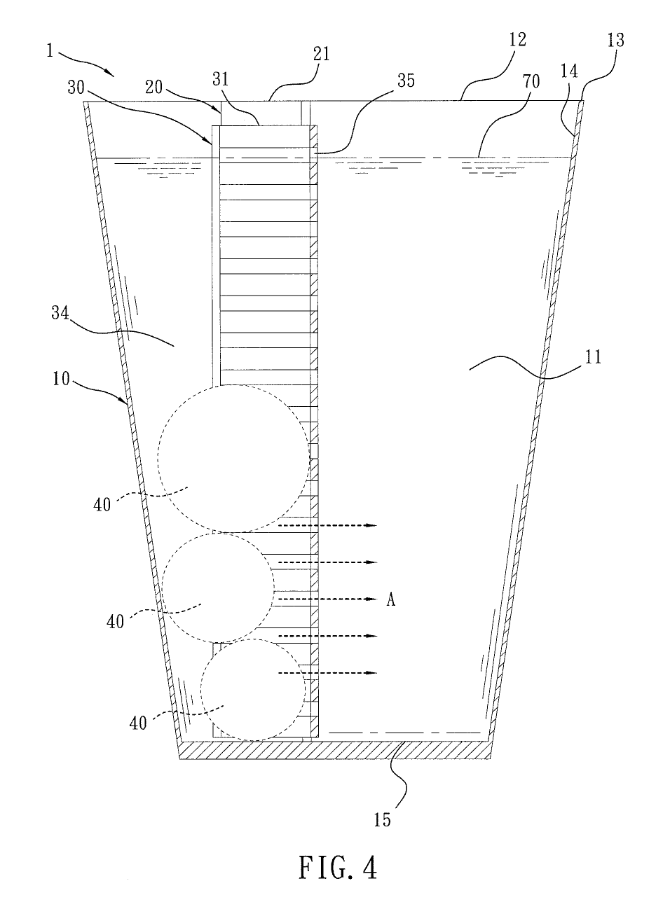

A top end 21 of each rib 20 is parallel to the opening edge 13 of the container body 10, as shown in FIG. 1 and FIG. 4. Such arrangement is beneficial to design, manufacturing and molding of the manufacturers.

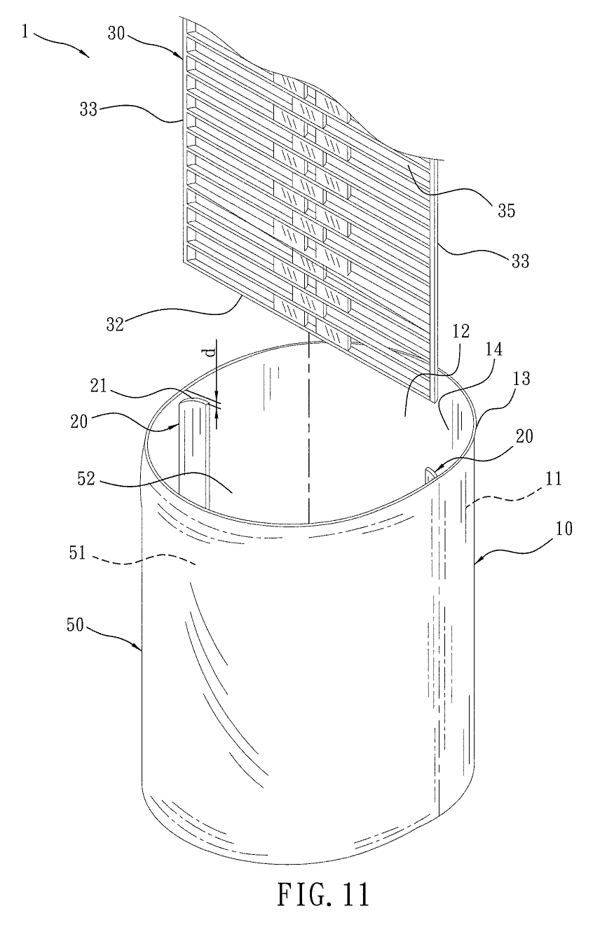

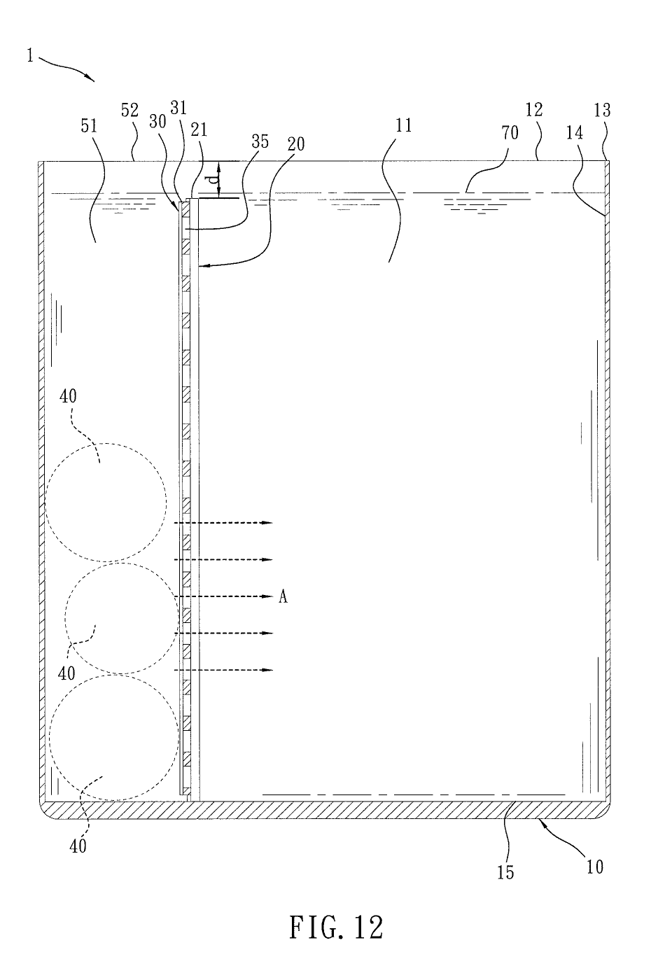

The top end 21 of each rib 20 is lower than the opening edge 13 of the container body 10 and the distance therebetween is d, as shown in FIG. 11 and FIG. 12. A top side 31 of the netlike piece 30 is lower than the opening edge 13 of the container body 10, as shown in FIG. 12. Thereby users' mouth will not be in contact with the rib 20 while they are sipping drinks so that they will not feel uncomfortable.

As shown in FIG. 1, the soft and elastic netlike piece 30 consists of an upper side 31, a lower side 32, two lateral sides 33 and a plurality of meshes 35. The shape, size or pattern of the mesh 35 is not limited, able to be modified according to user's requirements. For example, the netlike piece 30 can be a grating while the mesh 35 can be (a grating with) a horizontal slot (as shown in FIG. 1), a vertical slot, hole or a combination thereof. The netlike piece 30 is preferably formed by plastic injection molding. Thus not only the netlike piece 30 produced is soft and elastic, the production cost is also lowered.

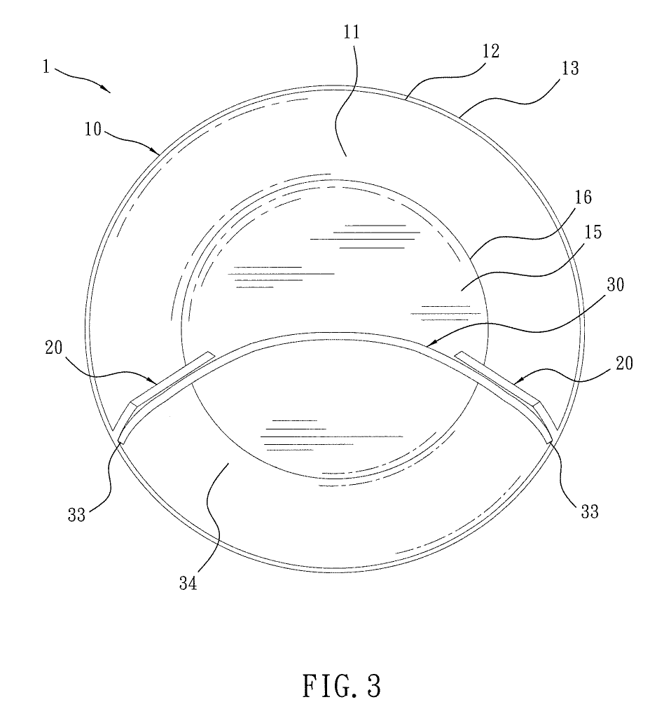

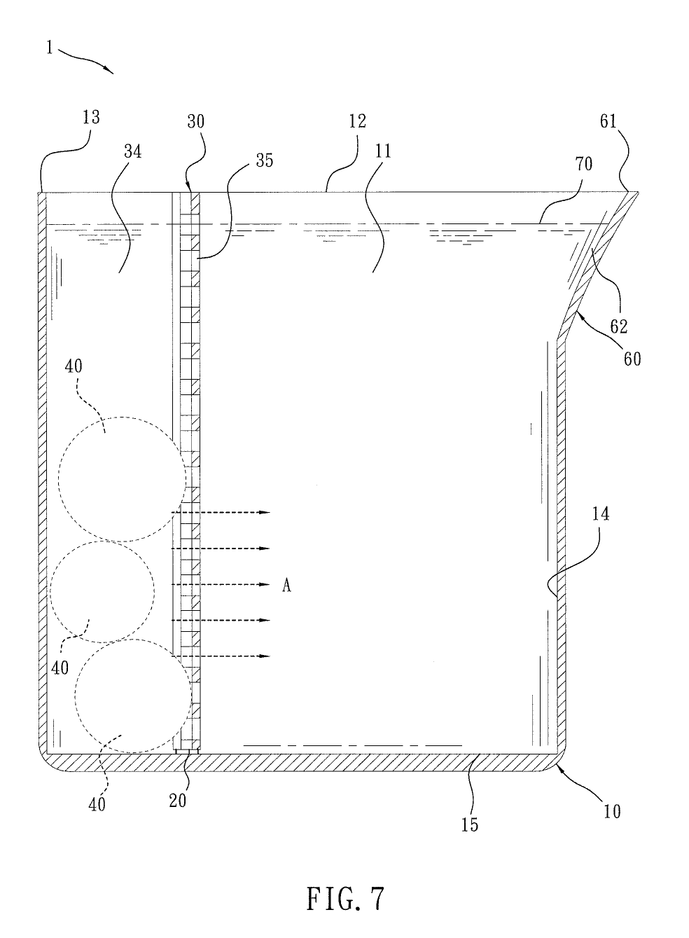

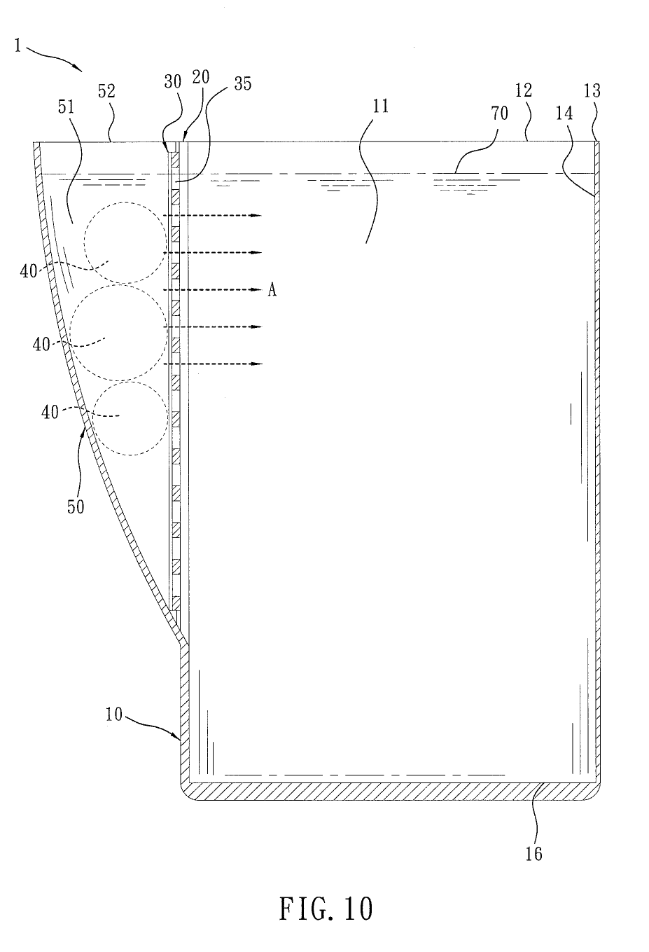

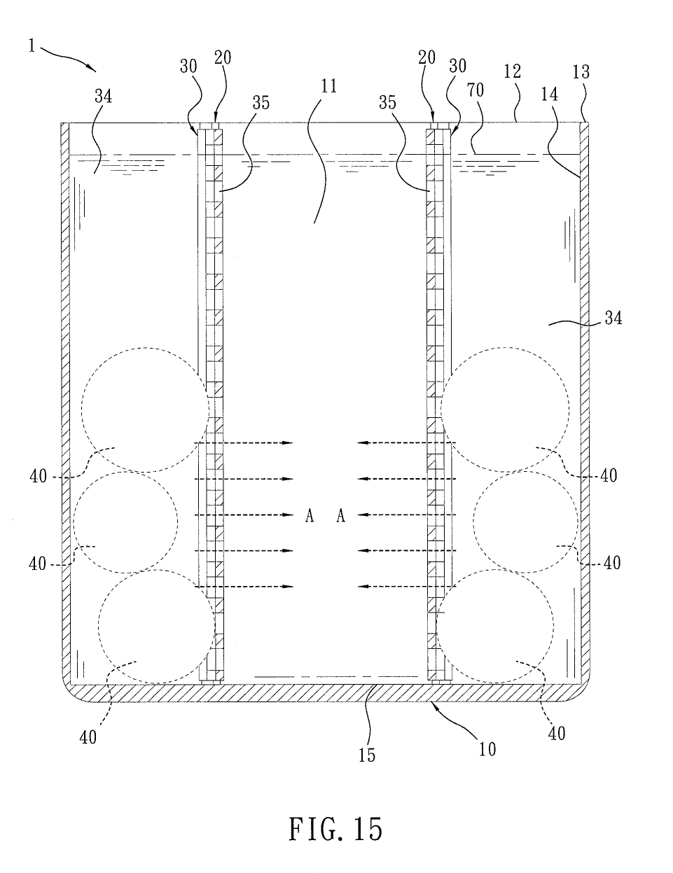

While in use, the netlike piece 30 is inserted into the cavity 11 through the opening 12 of the container body 10 so that the two lateral sides 33 of the netlike piece 30 are slid along the two ribs 20 respectively and the lower side 32 of the netlike piece 30 is also moved downward to be close to the inner bottom rim 16 of the container body 10. Then the two lateral sides 33 are stopped and locked by the two ribs 20 respectively owing to softness and elasticity of the netlike piece 30, as shown in FIG. 3. The cavity 11 of the container body 10 is divided by the netlike piece 30 to form a steeping chamber 34 used for mounting at least one soaked object 40. The soaked object 40 can be tea leaves, tea bags, fruits, or ice/ice packs used for cooling, etc. The steeping chamber 34 is communicated with the cavity 11 of the container body 10 by the meshes 35 of the netlike piece 30, as the arrow A in FIG. 4, FIG. 7, FIG. 10, FIG. 12, and FIG. 15 indicates. Thereby, the filtering function, steeping function or the cooling function is provided.

The users' mouth can reach the opening 12 of the container body 10 when they want to drink beverage 70 in the container body 10. They can sip the beverage 70 directly through the opening 12 or through a straw inserted into the cavity 11 and passed through the opening 12 of the container body 10.

The lower side 32 of the netlike piece 30 is close to the inner bottom rim 16 of the container body 10 while the netlike piece 30 being inserted into the container body 10, as shown in FIG. 4, FIG. 7, FIG. 10, FIG. 12, and FIG. 15.

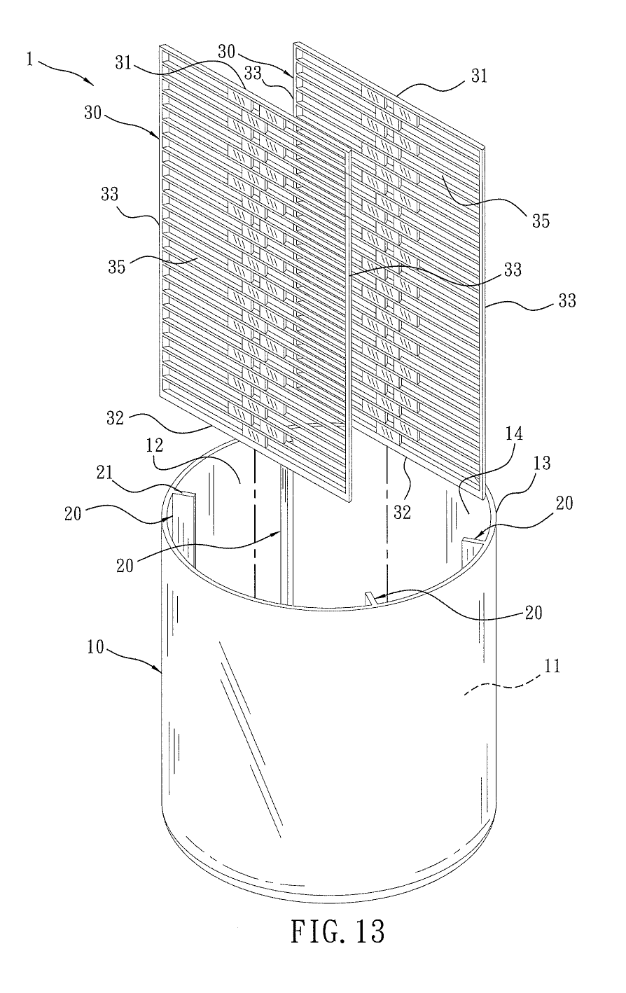

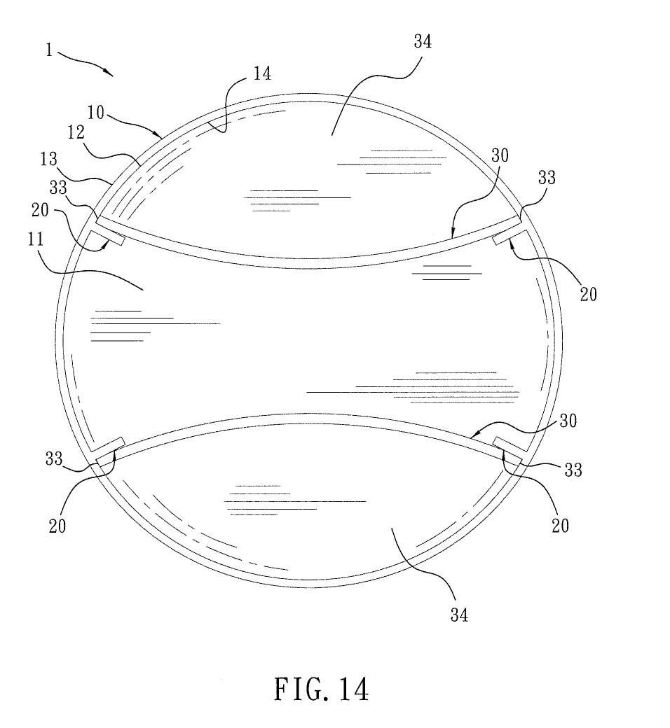

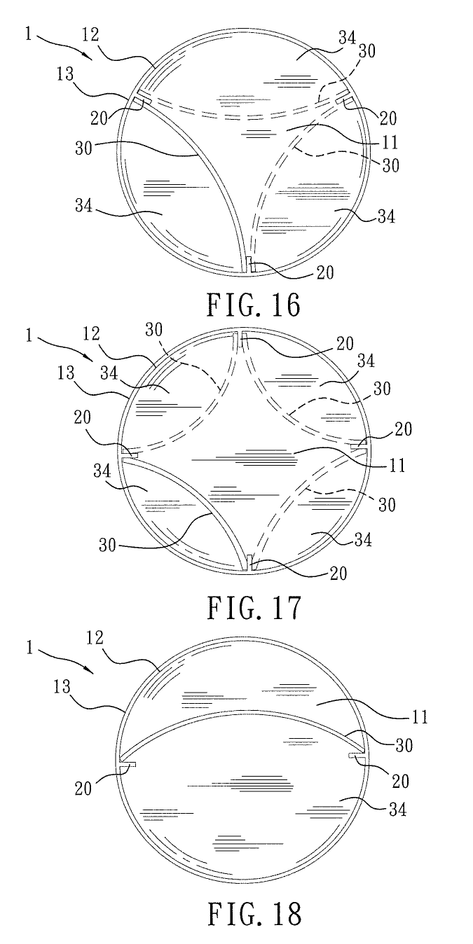

Refer to FIG. 16, the inner wall 14 of the container body 10 can also be disposed with three ribs 20, as shown in FIG. 16, or four ribs 20 as shown in FIG. 13, FIG. 14, and FIG. 17. This can increase the variability of the netlike piece 30 while in use. Moreover, the manufacturers can arrange the at least two ribs 20 (such as two, three or four ribs) at the inner wall 14 of the container body 10 with different interval between the two adjacent ribs 20 (as shown in FIG. 3 and FIG. 14) or the same interval between the two adjacent ribs 20 (as shown in FIG. 16, FIG. 17, and FIG. 18) according to their special needs. Thus consumers have more options.

Used the in combination with the ribs 20, the number of the netlike piece 30 inserted into the container body 10 can also be changed. For example, two netlike pieces 30 are used in the FIG. 13 and FIG. 14 and three netlike pieces 30 are shown in FIG. 16 while the embodiment in FIG.

17 includes four netlike pieces 30. Thus the consumers have more options while using the netlike pieces 30.

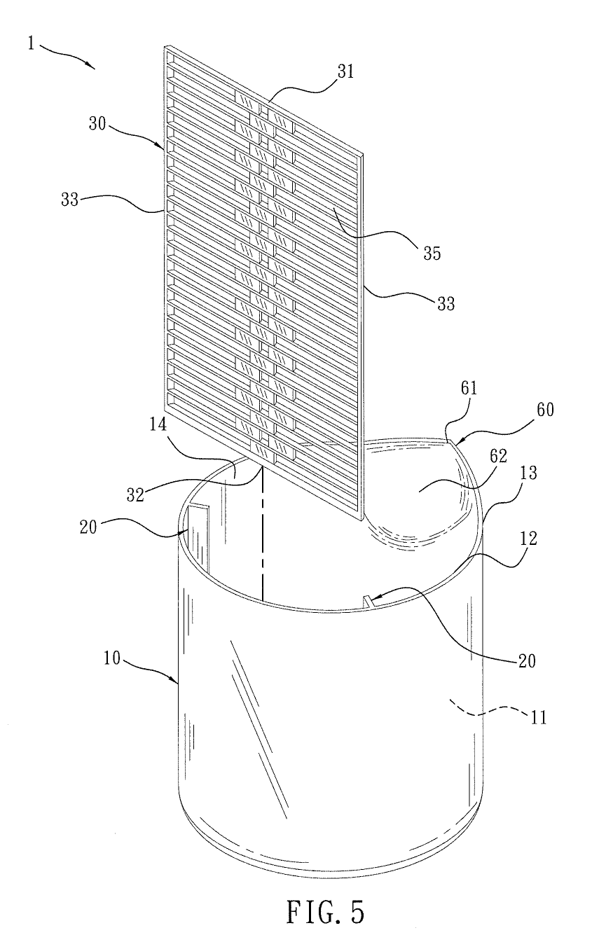

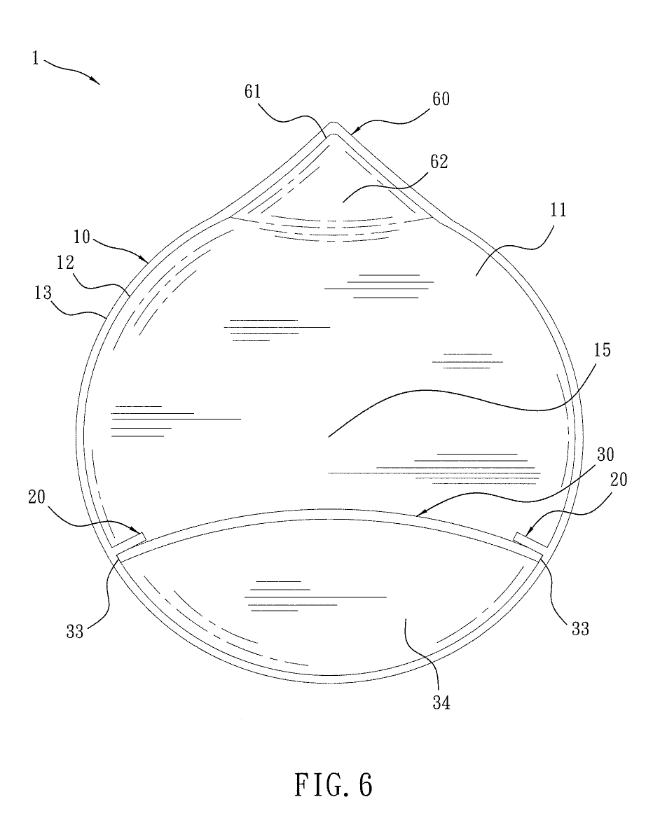

Furthermore, the netlike piece 30, an integrated part produced by plastic injection molding and having softness and elasticity, is designed to have a width (the distance between the two lateral sides 33 of the netlike piece 30) larger than that between two of the ribs 20. Thus the netlike piece 30 can be elastically curved to be locked between two of the ribs 20 disposed on the inner wall 14 of the container body 10, as shown in FIG. 1 and FIG. 3, FIG. 5 and FIG. 6, or FIG. 13 and FIG. 14. That means the netlike piece 30 locked between two of the ribs 20 is compressed and squeezed to be curved. Thereby the netlike piece 30 is stably positioned, without getting loose or falling off after being arranged into the container body 10.

As shown in FIG. 3 or FIG. 18, users can decide the position of the steeping chamber 34 freely according to their needs when the netlike piece 30 is stopped and locked by two of the ribs 20 to be pressed and curved therebetween and the steeping chamber 34 is formed in the cavity 11 of the container body 10. For example, the space of the steeping chamber 34 of the embodiment in FIG. 3 is smaller than that of the rest of the cavity 11. Refer to FIG. 18, the space of the steeping chamber 34 is larger than that of the rest of the cavity 11. Thus users have more options.

The shape of the container body 10, the number of the ribs 20 disposed and the number of the netlike piece 30 are not limited.

Refer to the embodiment shown in FIG. 1 to FIG. 4, the container body 10 is an inverted truncated cone tapered from the opening 12 to the bottom side thereof. The two ribs 20 are arranged along the sloped inner wall 14 of the container body 10 and extended to the inner bottom surface 15. The two lateral sides 33 of the netlike piece 30 are also tapered and sloped like the inner wall 14 to form a trapezoid whose upper base is longer than the lower base. While in use, the netlike piece 30 is inserted into the cavity 11 through the opening 12 of the container body 10 to form the steeping chamber 34 in the cavity 11 of the container body 10. The steeping chamber 34 is used to receive at least one soaked object 40.

Refer to FIG. 5, FIG. 6 and FIG. 7, in this embodiment, the container body 10 is a cylinder set vertically, with the opening 12 facing upward. The two ribs 20 are vertically extended along the inner wall 14 of the container body 10 to the inner bottom surface 15. The two lateral sides 33, the upper side 31 and the lower side 32 of the netlike piece 30 form a rectangular piece. Moreover, the opening edge 13 of the container body 10 is further extended outward to form a sloped and projecting discharge portion 60. The discharge portion 60 including a discharge spout 61 and a discharge channel 62 is communicated with the cavity 11 of the container body 10. The user can pour the beverage 70 in the cavity 11 of the container body 10 into other container smoothly by the discharge portion 60.

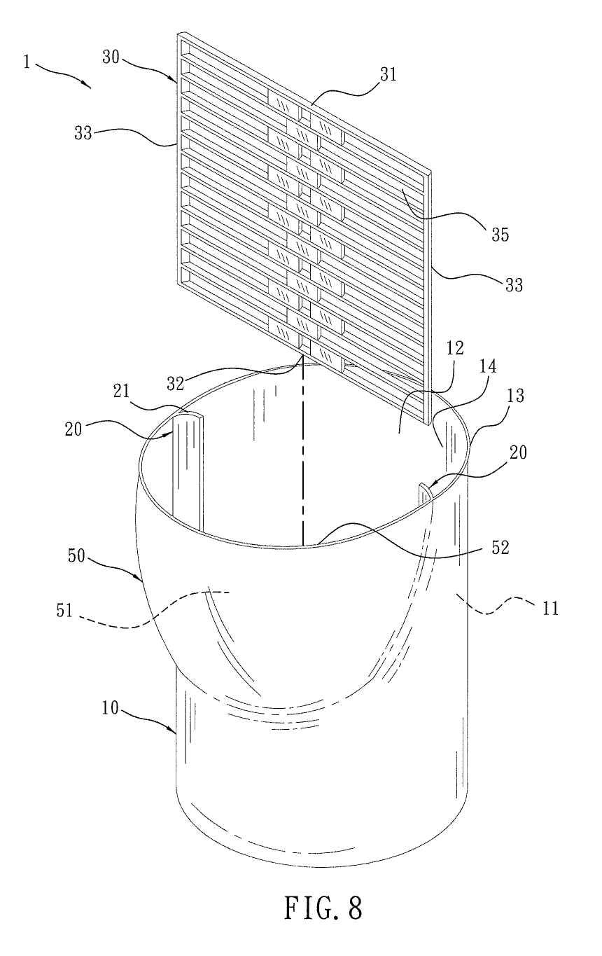

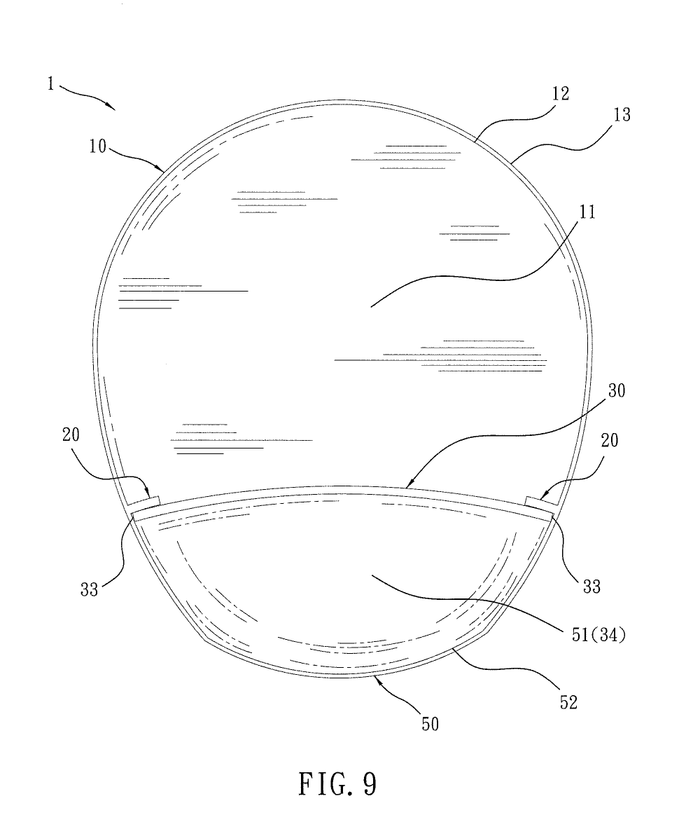

Refer to FIG. 8, FIG. 9 and FIG. 10, in this embodiment, the container body 10 is a cylinder set vertically, with the opening 12 facing upward. A curved convex portion 50 projecting outward is disposed on one side of the container body 10 and extended from the opening edge 13 to a middle part of the container body 10. The curved convex portion 50 is having a mounting space 51 and a curved opening 52 and is communicated with the cavity 11 of the container body 10. The two ribs 20 are extended from the connection area between the curved opening 52 and the opening 12 to the inner bottom surface 15 of the container body 10. The netlike piece 30 that is a rectangular piece extended from the upper side 31 to the lower side 32 is inserted into the cavity 11 through the connection area between the opening 12 of the container body 10 and the curved opening 52. Thus the mounting space 51 of the curved convex portion 50 is isolated by the netlike piece 30 to form the steeping chamber 34 that is mounted with at least one soaked object 40. Thereby the combination of the container body 10 with the netlike piece 30 has changes while in use.

As to the embodiment in FIG. 11 and FIG. 12, the curved convex portion 50 is formed by extension of the curved opening 52 toward the bottom side of the container body 10. This embodiment can be considered as a modification of the embodiment shown in FIG. 8 to FIG. 10.

Refer to FIG. 13, FIG. 14 and FIG. 15, in this embodiment, the container body 10 is a cylinder set vertically. Four ribs 20 are arranged at the inner wall 14 of the container body 10 in parallel and symmetrically. The netlike piece 30 is a rectangle extended from the upper side 31 to the lower side 32. The container body 10 is further inserted with the two netlike pieces 30 so that the cavity 11 of the container body 10 is divided to form two steeping chambers 34 each of which is used to receive at least one soaked object 40 therein. This is another combination of the container body 10 and the netlike pieces 30.

Compared with prior arts, the filtering and steeping container 1 of the present invention has the following advantages:
(1). The present container 1 provides filtering and steeping effects only by the at least one netlike piece 30 being inserted into the container body 10. For cleaning, only the netlike piece/pieces 30 needs/need to be removed from the container body 1. Thus assembly, disassembly and cleaning of the container 1 are more convenient than ever.
(2). The present container 1 only consist of at least one netlike piece 30 and the container body 10. The simple structure makes the container 1 easy to produce so that the production cost is lowered and the market competitiveness is enhanced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A filtering and steeping container comprising:
a container body including a cavity therein, an opening facing upward, an opening edge, an inner wall, an inner bottom surface and an inner bottom rim; and
at least one netlike piece having an upper side, a lower side, two lateral sides and a plurality of meshes;
wherein at least two vertical ribs are integrally formed on the inner wall of the container body and projecting from the inner wall of the container body toward the cavity; the rib having a certain length and a certain thickness and extended from an area close to the opening edge to the inner bottom surface of the container body;
wherein the netlike piece is inserted into the cavity through the opening of the container body so that the two lateral sides of the netlike piece are slid along two of the ribs respectively and the lower side of the netlike piece is also moved downward to be close to the inner bottom surface of the container body; then the two lateral sides are stopped and locked by the two ribs respectively owing to softness and elasticity of the netlike piece; the cavity of the container body is divided by the netlike piece to form a steeping chamber used for mounting at least one soaked object; the steeping chamber is communicated with the cavity of the container body by the meshes of the netlike piece.

2. The device as claimed in claim 1, wherein the container body is an inverted truncated cone tapered from the opening to a bottom side thereof; wherein the ribs are slopingly arranged along the inner wall of the container body and extended to the inner bottom surface; wherein the two lateral sides of the netlike piece are tapered from the upper side to the lower side according to a slope of the inner wall to form a trapezoid whose upper base is longer than the lower base.

3. The device as claimed in claim 1, wherein the container body is a cylinder set vertically and extended from the opening to a bottom side thereof; the ribs are vertically extended along the inner wall of the container body to the inner bottom surface; the netlike piece is a rectangular piece.

4. The device as claimed in claim 1, wherein the lower side of the netlike piece is located on and close to the inner bottom surface of the container body when the netlike piece is inserted into the cavity of the container body.

5. The device as claimed in claim 1, wherein a curved convex portion projecting outward is disposed on the container body and extended from the opening edge to a middle part of the container body; the curved convex portion is including a mounting space and a curved opening and is communicated with the cavity of the container body; wherein the ribs are extended from connection area between the curved opening and the opening to the inner bottom surface of the container body.

6. The device as claimed in claim 5, wherein the curved convex portion is extended from the curved opening to a bottom side of the container body.

7. The device as claimed in claim 1, wherein the number of the ribs can be two, three or four.

8. The device as claimed in claim 1, wherein the number of the netlike piece can be one, two, three or four.

9. The device as claimed in claim 1, wherein a discharge portion projecting outward is arranged at the opening edge of the container body; the discharge portion is having a discharge spout and a discharge channel, and is communicated with the cavity of the container body.

10. The device as claimed in claim 1, wherein the container body is one part integrally formed by plastic injection molding.

11. The device as claimed in claim 1, wherein the netlike piece is one part integrally formed by plastic injection molding.

12. The device as claimed in claim 1, wherein a distance between the two lateral sides of the netlike piece is no less than a distance between two of the ribs so that the netlike piece is able to be elastically curved to be locked between two of the ribs disposed on the inner wall of the container body; wherein the upper side and the lower side of the netlike piece become curved when the two lateral sides of the netlike piece are stopped and locked by two of the ribs.
